(19) United States
(12) Patent Application Publication
(10) Pub. No.: US 2005/0202155 A1
(43) Pub. Date: Sep. 15, 2005

(54) Catnip enhanced pet food product

(76) Inventor: Aaron M. Lamstein, San Rafael, CA (US)

Correspondence Address: DERGOSITS & NOAH LLP, Suite 1450, Four Embarcadero Center, San Francisco, CA, 94111, US

(21) Appl. No.: 10/801,327

(22) Filed: Mar. 15, 2004

(51) Int. Cl. A01K 1/00

(52) U.S. Cl. 426/656; 426/2

(57) ABSTRACT

A pet food for consumption by cats. The food consists of a basic food product such as shrimp, chicken, such as chicken liver and chicken heart, other fish products such as tuna, beef products and turkey having a low moisture content and a quantity of catnip associated therewith.

### TECHNICAL FIELD AND INVENTION

The present invention involves a pet food for consumption by animals and particularly cats. The pet food recognizes the synergistic relationship between basic food products and catnip and provides for an effective combination of catnip and a basic food as a nutritious and enjoyable pet treat.

### BACKGROUND OF THE INVENTION

It is quite common to provide catnip to felines in a wide variety of delivery systems. For example, it is commonplace to incorporate catnip in various feline toys and even in food products. The effect of catnip on virtually all feline species is well known. Catnip or nepatia cataria is a plant native to North America. The dry leaves of the catnip plant express a mint-like scent. Catnip has a hallucinogenic effect upon cats, although it is not toxic. This “catnip response” is due to the plant's active ingredient, nepetalactone.

When a cat smells catnip, it characteristically exhibits a range of behaviors somewhat dependent upon the age of a cat, genetics, and whether it is capable of reproduction. Most reactions last from 5-to-15 minutes and include sniffing, licking and chewing, chin and cheek rubbing, hip and head-over roll and body rubbing. The feline receptor for the active ingredient, nepetalactone is contained within the animal's vomeronasal organ located above the feline palate. The location of the vomeronasal organ may explain why cats do not react from eating gelatin capsules of catnip. The nepetalactone must be inhaled for it to reach the receptors in this organ.

There have been prior attempts to incorporate catnip into food products. For example, a company by the name of COSMIC® Pet Products sells COSMIC® Catnip Treats, which includes a combination of various basic foods such as wheat flour, poultry, soy flour, dried whey, shrimp, lobster and yeast having a moisture content of 34 percent. The company also offers a dried catnip product in a shaker for sprinkling on food. However, neither approach to the combination of catnip and pet food has proven to be ideal.

Those in the past who have offered products which include a basic pet food and catnip have recognized the benefits from this combination. Adding catnip to a basic food product makes the food product much more appealing to the cat and turns what would otherwise be a mundane and routine eating experience into what amounts to a highly desirable treat. Typically, the fussiest of feline eaters enthusiastically embrace this combination. Nevertheless, the combination of a basic food product with catnip has not been as commercially acceptable as one would otherwise anticipate.

There are several reasons why prior catnip-based food products have enjoyed only modest commercial acceptance. The first impediment is based upon applicant's recognition that wet or moist food products containing catnip are inherently compromised. Food products containing high moisture content tend to degrade the catnip particularly when stored for long periods of time. Also, in such products, the catnip tends to imbed within morsels of the food product inhibiting the “catnip response” which, as noted earlier, requires activation of the feline receptor contained within the animal's vomeronasal organ. This becomes the equivalent of a catnip capsule which, again as noted previously, is ineffective in producing the desired response. Dried catnip in the form of a shaker for application to a pet food suffers from the fact that average consumer is incapable of determining the ideal quantity of catnip to be applied to the food product.

It is thus an objection of the present invention to provide a pet food for consumption by cats which includes a basic food product having low moisture content and a quantity of catnip thus obviating the limitations of the prior art.

This and further objects will be more readily appreciated when considering the following disclosure and appended claims.

### SUMMARY OF THE INVENTION

The present invention is directed to a pet food for consumption by cats comprising a basic food product having a low moisture content and a quantity of catnip associated therewith. Ideally, the pet food is prepared by freeze drying the basic food product to provide a moisture content less than approximately 10%.

### DETAILED DESCRIPTION OF THE INVENTION

The basic food product of the present invention can comprise a naturally occurring food, such as shrimp, chicken, such as chicken liver and chicken heart, other fish products such as tuna, beef products and turkey, or a blend of various food products including fish, poultry and meat derivatives. In production, the basic food product is processed to reduce its moisture content to a level less than approximately 10% by eight. This can be done by freeze-drying or by using any other method to achieve the appropriate result. By reducing moisture content below the levels employed by the prior art, the viability of the catnip is maintained while making it available to the animal's vomeronasal organ thus achieving the appropriate “catnip response.”

It is anticipated that the pet food product of the present invention would be prepared by drying the appropriate basic food and coating it with a quantity of catnip suitable for ingestion by a domestic cat. Currently, one teaspoon of catnip is used per ounce of food product. However, because the basic food is relatively dry, the dried leaves of the catnip plant tends to separate from the basic food providing a package with the basic food and a concentrated mass of the dried catnip plant leaf having accumulated at the bottom of the container. Thus, the packaging would have a predetermined and correct quantity of the catnip leaf and basic food product requiring only that a user thoroughly shake the contents together to create the desired basic food product coated with the desired predetermined amount of catnip. Thus, during shipment and storage, the vitality of the catnip is maintained and upon use, the basic food product is coated with the desired amount of catnip being coated thereon.

1. A pet food for consumption by cats comprising of basic food product having a low moisture content and a quantity of catnip associated therewith.

2. The pet food of claim 1 wherein said basic food product is freeze dried.

3. The pet food of claim 1 wherein said basic food product has a moisture content less than approximately 10%.

4. The pet food of claim 1 wherein said basic food product comprises a member selected from the group consisting of shrimp, chicken, such as chicken liver and chicken heart, other fish products such as tuna, beef products and turkey.

5. The pet food of claim 1 wherein approximately one teaspoon of catnip is provided per ounce of the basic food product.

6. The pet food of claim 1 wherein said catnip is coated upon a surface of said basic food product.

7. A pet food for consumption by cats comprising a basic food product selected from the group consisting of shrimp, chicken, such as chicken liver and chicken heart, other fish products such as tuna, beef products and turkey having a moisture content less than approximately 10%.

8. The pet food of claim 7 wherein said basic food product is freeze dried.

9. The pet food of claim 7 wherein approximately one teaspoon of catnip is provided per ounce of the weight of the basic food product.
